(19) United States
(12) Patent Application Publication
(10) Pub. No.: US 2022/0412569 A1
(43) Pub. Date: Dec. 29, 2022

(54) Microwave Oven Cleaning Assembly

(71) Applicant: Rosalyn Smoot, Chicago, IL (US)

(72) Inventor: Rosalyn Smoot, Chicago, IL (US)

(21) Appl. No.: 17/361,869

(22) Filed: Jun. 29, 2021

(51) Int. Cl. F24C 14/00; F24C 7/02

(52) U.S. Cl. CPC F24C 14/005; F24C 7/02

(57) ABSTRACT

A microwave oven cleaning assembly includes a cup that contains a cleaning solution. The cup is comprised of a microwave safe material to facilitate the cup to be heated in a microwave. Moreover, the cleaning solution is vaporized into a steam when the cleaning solution is heated above a boiling temperature of the cleaning solution. In this way the steam cleans an interior of the microwave oven. A disk is positioned on the cup and the disk is foraminous thereby facilitating the steam to pass through the disk. A protective sheet is removably bonded to the disk to inhibit the cleaning solution from evaporating. The protective sheet is removable from the disk when the cleaning solution is heated thereby facilitating the steam to pass through the disk.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cleaning devices and more particularly pertains to a new cleaning device for steam cleaning an interior of a microwave oven. The device includes a cup which contains a cleaning solution, a foraminous disk that covers the cup and a protective sheet that is removable from the foraminous disk. The protective sheet is removed from the foraminous disk and the cup is heated in the microwave oven to facilitate steam from the cleaning solution to clean the microwave oven.

### (2) Description of Related Art Including Information Disclosed Under 37 CFR 1.97 and 1.98

The prior art relates to cleaning devices including a variety of open cell containers, filled with a solution, that is heated in a microwave oven for cleaning an interior of the microwave oven with steam. The prior art also discloses a container that contains an absorbent sponge which is soaked with a cleaning solution. The container is heated in a microwave oven for cleaning an interior of the microwave oven with steam. The prior art also discloses a dissolvable tablet that can be positioned in a microwave oven for releasing cleaning steam in the microwave oven. In no instance does the prior art disclose a cleaning device that includes a cup, a foraminous disk placed on the cup and a protective sheet removably bonded to the foraminous disk.

### BRIEF SUMMARY OF THE INVENTION

An embodiment of the disclosure meets the needs presented above by generally comprising a cup that contains a cleaning solution. The cup is comprised of a microwave safe material to facilitate the cup to be heated in a microwave. Moreover, the cleaning solution is vaporized into a steam when the cleaning solution is heated above a boiling temperature of the cleaning solution. In this way the steam cleans an interior of the microwave oven. A disk is positioned on the cup and the disk is foraminous thereby facilitating the steam to pass through the disk. A protective sheet is removably bonded to the disk to inhibit the cleaning solution from evaporating. The protective sheet is removable from the disk when the cleaning solution is heated thereby facilitating the steam to pass through the disk.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a microwave oven cleaning assembly according to an embodiment of the disclosure.

FIG. 2 is a front view of an embodiment of the disclosure.

FIG. 3 is a top view of an embodiment of the disclosure.

FIG. 4 is a cross sectional view taken along line 4-4 of FIG. 2 of an embodiment of the disclosure.

FIG. 5 is a perspective in-use view of an embodiment of the disclosure.

### DETAILED DESCRIPTION OF THE INVENTION

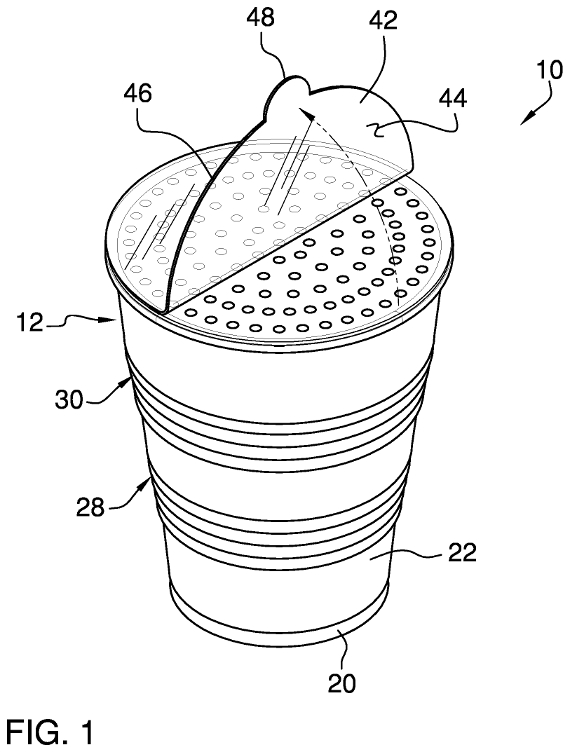

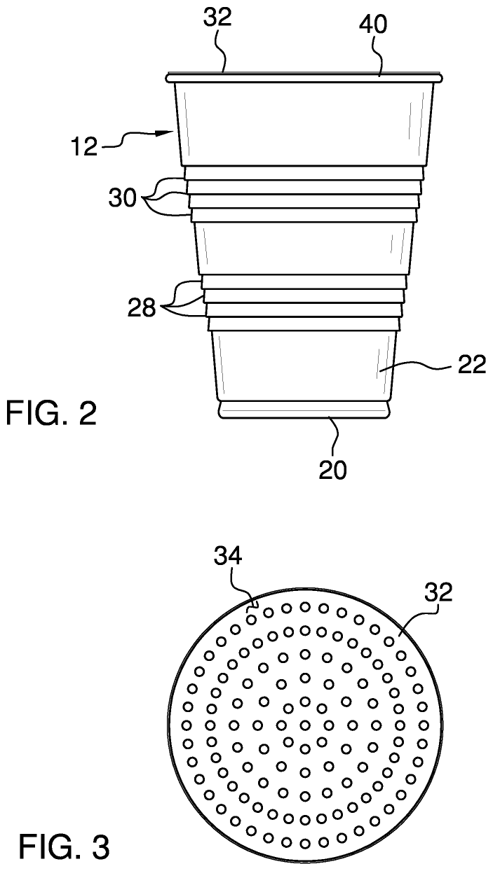

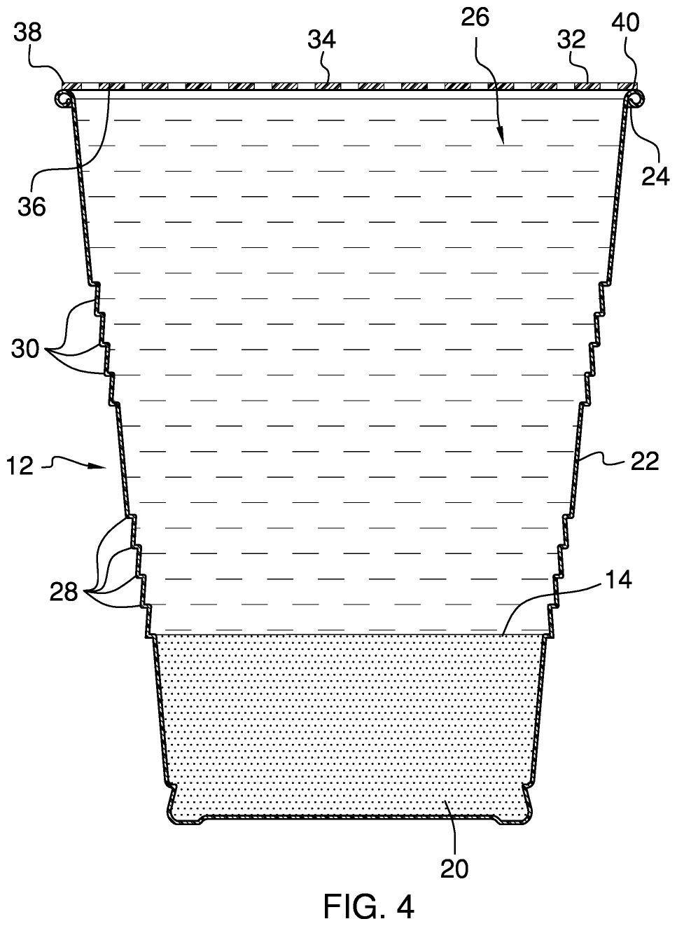

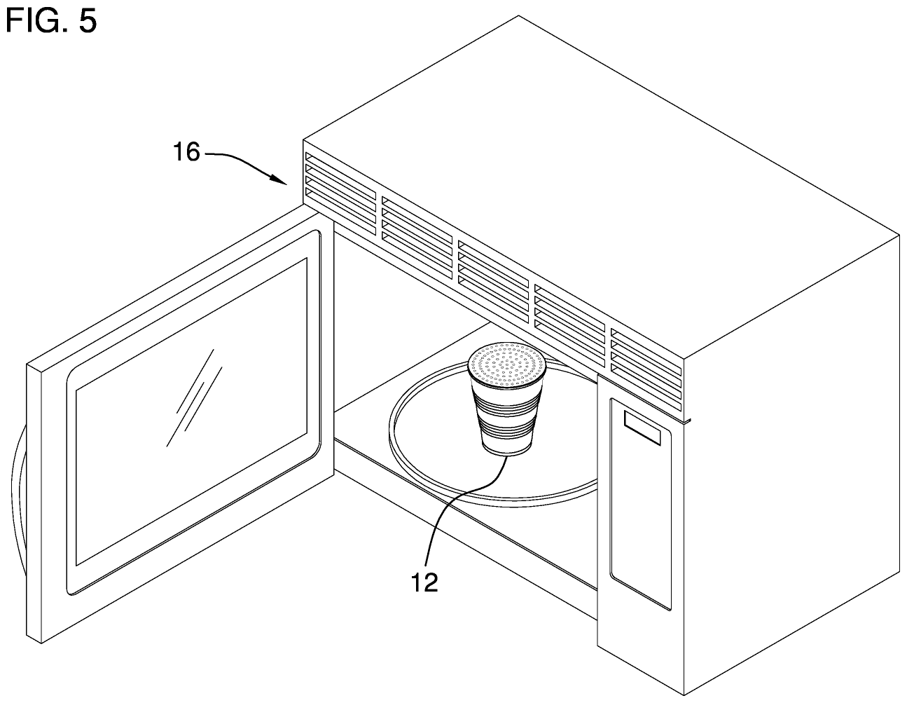

With reference now to the drawings, and in particular to FIGS. 1 through 5 thereof, a new cleaning device embodying the principles and concepts of an embodiment of the disclosure and generally designated by the reference numeral 10 will be described.

As best illustrated in FIGS. 1 through 5, the microwave oven cleaning assembly 10 generally comprises a cup 12 that contains a cleaning solution 14. The cleaning solution 14 may comprise a mixture of water and either a liquid or a powdered cleaner. The cup 12 is comprised of a microwave safe material thereby facilitating the cup 12 to be heated in a microwave oven 16 without being damaged or deformed. The cleaning solution 14 is vaporized into a steam when the cleaning solution 14 is heated above a boiling temperature of the cleaning solution 14. In this way the steam coats an interior of the microwave oven 16 when the cleaning solution 14 is heated in the microwave thereby facilitating the cleaning solution 14 to clean the interior of the microwave oven 16

The cup 12 has a bottom wall 20 and an outer wall 22 extending upwardly from the bottom wall 20, and the outer wall 22 has a distal edge 24 with respect to the bottom wall 20 defining an opening 26 into the cup 12. The outer wall 22 flares outwardly between the bottom wall 20 and the distal edge 24 such that the opening 26 has a diameter which is greater than the diameter of the bottom wall 20. The outer wall 22 has a set of first ridges 28 integrated therein, each of the first ridges 28 extends around a full circumference of the outer wall 22 and each of the first ridges 28 is spaced from bottom wall 20. The outer wall 22 has a set of second ridges 30 is integrated therein and each of the second ridges 30 extends around a full circumference of the outer wall 22. Each of the second ridges 30 is positioned between the set of first ridges 28 and the distal edge 24 of the outer wall 22. Additionally, the outer wall 22 curls onto itself such that the distal edge 24 abuts an outer surface of the outer wall 22.

A disk 32 is provided and the disk 32 is positioned on the cup 12 such that the disk 32 closes the cup 12. Moreover, the disk 32 is foraminous thereby facilitating the steam to pass through the disk 32 when the cleaning solution 14 is heated. The disk 32 has an upper surface 34, a lower surface 36 and a perimeter edge 38 extending between the upper surface 34 and the lower surface 36. The lower surface 36 rests upon a curl 40 defined by the outer wall 22 curling onto itself such that the disk 32 completely covers the opening 26 into the cup 12. The disk 32 is comprised of a microwave safe material thereby facilitating the disk 32 to be heated in the microwave oven 16 without being damaged or deformed.

A protective sheet 42 is provided and the protective sheet 42 is removably bonded to the disk 32. The protective sheet 42 is comprised of a fluid impermeable material such that the protective sheet 42 inhibits the cleaning solution 14 from evaporating. Moreover, the protective sheet 42 is removable from the disk 32 when the cleaning solution 14 is heated thereby facilitating the steam to pass through the disk 32. The protective sheet 42 has a first surface 44 and an outer edge 46, and the first surface 44 is removably bonded to the upper surface 34 of the disk 32 having the protective sheet 42 completely covering the upper surface 34. The outer edge 46 has a lobed portion 48 extending outwardly beyond a circumference of the outer edge 46 such that the lobed portion 48 extends outwardly beyond the outer wall 22 of the cup 12. In this way the lobed portion 48 can be gripped for removing the protective sheet 42 from the disk 32.

In use, the lobed portion 48 of the protective sheet 42 is gripped to remove the protective sheet 42 from the disk 32. The cup 12 is placed inside the microwave oven 16 and the microwave oven 16 is turned on for sufficient duration of time to vigorously boil the cleaning solution 14 in the cup 12. In this way steam from the boiling cleaning solution 14 passes through the disk 32 and coats the interior of the microwave oven 16.

The cup 12 is removed from the microwave oven 16 when the microwave oven 16 turns off and the interior of the microwave oven 16 is wiped clean, if necessary. Thus, the interior of the microwave oven 16 can be steam cleaned without requiring the interior of the microwave oven 16 to be manually scrubbed. In this way a professional cleaner, for example, can easily clean a plurality of microwave ovens that might be found in a large office building or other similar location.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A microwave oven cleaning assembly for cleaning an interior of a microwave oven with a chemical steam, said assembly comprising:
a cup containing a cleaning solution, said cup being comprised of a microwave safe material wherein said cup is configured to be heated in a microwave, said cleaning solution being vaporized into a steam when said cleaning solution is heated above a boiling temperature of said cleaning solution wherein said steam is configured to coat an interior of the microwave oven when said cleaning solution is heated in the microwave;
a disk being positioned on said cup such that said disk closes said cup, said disk being foraminous thereby facilitating said steam to pass through said disk when said cleaning solution is heated; and
a protective sheet being removably bonded to said disk, said protective sheet being comprised of a fluid impermeable material such that said protective sheet inhibits said cleaning solution from evaporating, said protective sheet being removable from said disk when said cleaning solution is heated thereby facilitating said steam to pass through said disk.

2. The assembly according to claim 1, wherein:
said cup has a bottom wall and an outer wall extending upwardly from said bottom wall, said outer wall having a distal edge with respect to said bottom wall defining an opening into said cup, said outer wall flaring outwardly between said bottom wall and said distal edge such that said opening has a diameter being greater than the diameter of said bottom wall;
said outer wall has a set of first ridges being integrated therein, each of said first ridges extending around a full circumference of said outer wall, each of said first ridges being spaced from bottom wall;
said outer wall has a set of second ridges being integrated therein, each of said second ridges extending around a full circumference of said outer wall, each of said second ridges being positioned between said set of first ridges and said distal edge of said outer wall; and
said outer wall curls onto itself such that said distal edge abuts an outer surface of said outer wall.

3. The assembly according to claim 2, wherein said disk has an upper surface, a lower surface and a perimeter edge extending between said upper surface and said lower surface, said lower surface resting upon a curl defined by said outer wall curling onto itself such that said disk completely covers said opening into said cup.

4. The assembly according to claim 1, wherein:
said disk has an upper surface;
said cup has an outer wall; and
said protective sheet has a first surface and an outer edge, said first surface being removably bonded to said upper surface of said disk having said protective sheet completely covering said upper surface, said outer edge having a lobed portion extending outwardly beyond a circumference of said outer edge such that said lobed portion extends outwardly beyond said outer wall of said cup wherein said lobed portion is configured to be gripped for removing said protective sheet from said disk.

5. A microwave oven cleaning assembly for cleaning an interior of a microwave oven with a chemical steam, said assembly comprising:
a cup containing a cleaning solution, said cup being comprised of a microwave safe material wherein said cup is configured to be heated in a microwave, said cleaning solution being vaporized into a steam when said cleaning solution is heated above a boiling temperature of said cleaning solution wherein said steam is configured to coat an interior of the microwave oven when said cleaning solution is heated in the microwave, said cup having a bottom wall and an outer wall extending upwardly from said bottom wall, said outer wall having a distal edge with respect to said bottom wall defining an opening into said cup, said outer wall flaring outwardly between said bottom wall and said distal edge such that said opening has a diameter being greater than the diameter of said bottom wall, said outer wall having a set of first ridges being integrated therein, each of said first ridges extending around a full circumference of said outer wall, each of said first ridges being spaced from bottom wall, said outer wall having a set of second ridges being integrated therein, each of said second ridges extending around a full circumference of said outer wall, each of said second ridges being positioned between said set of first ridges and said distal edge of said outer wall, said outer wall curling onto itself such that said distal edge abuts an outer surface of said outer wall;
a disk being positioned on said cup such that said disk closes said cup, said disk being foraminous thereby facilitating said steam to pass through said disk when said cleaning solution is heated, said disk having an upper surface, a lower surface and a perimeter edge extending between said upper surface and said lower surface, said lower surface resting upon a curl defined by said outer wall curling onto itself such that said disk completely covers said opening into said cup; and
a protective sheet being removably bonded to said disk, said protective sheet being comprised of a fluid impermeable material such that said protective sheet inhibits said cleaning solution from evaporating, said protective sheet being removable from said disk when said cleaning solution is heated thereby facilitating said steam to pass through said disk, said protective sheet having a first surface and an outer edge, said first surface being removably bonded to said upper surface of said disk having said protective sheet completely covering said upper surface, said outer edge having a lobed portion extending outwardly beyond a circumference of said outer edge such that said lobed portion extends outwardly beyond said outer wall of said cup wherein said lobed portion is configured to be gripped for removing said protective sheet from said disk.
